(19) United States
(12) Patent Application Publication
(10) Pub. No.: US 2014/0049430 A1
(43) Pub. Date: Feb. 20, 2014

(54) 3-Dimensional Antenna

(71) Applicant: Roy Donald Koski, II, West Bend, WI (US)

(72) Inventor: Roy Donald Koski, II, West Bend, WI (US)

(73) Assignee: GENERAL ELECTRIC COMPANY, Schenectady, NY (US)

(21) Appl. No.: 13/588,048

(22) Filed: Aug. 17, 2012

(51) Int. Cl. H01Q 1/36; H01P 11/00

(52) U.S. Cl. 343/700 MS; 29/600

(57) ABSTRACT

The system and method of the present application includes a 3-dimensional spherically-shaped antenna having multiple elements of various size based on self-similarity of repeated patterns, i.e., fractal antenna. This antenna provides a wide-band response to efficiently capture ambient electromagnetic energy that may be further processed and used to generate electricity. The antenna may also be tuned to provide a more accurate and efficient antenna capable of capturing a specific band of frequencies. The electricity collected may then be used to power various loads including electrical and electronic devices such as computers, cell phones, audio and video equipment, medical equipment, electrical appliances, lights, and numerous other devices. This may be particularly useful in remote locations, and can also compliment renewable energy sources such as solar, wind, thermal, and others. The antenna also provides increased reception for wireless communication applications, and may utilize fractal and non-fractal antennas.

### FIELD

The present application is directed to the field of electromagnetic antennas. More specifically, the present application is directed to the field of three-dimensional electromagnetic antennas.

### BACKGROUND

Antennas used today are generally based on 2-dimensional geometries and tuned for a relatively narrow band of frequencies. These antennas often require the antenna to be physically rotated or moved to improve the ability to receive the intended signal.

Furthermore, electromagnetic energy is present in the ambient surroundings from numerous sources including radio and television stations, cellular telephones and transmitters, 802.11 WiFi wireless devices and transmitters, microwave transmitters, radar transmitters, electromagnetic emissions emitted from electrical and electronic devices, numerous other devices and transmitters, and outer space. This electromagnetic energy is present in all directions within the environment, and therefore energy harvesting applications require a non-directional antenna capable of receiving electromagnetic energy over a very wide-band of frequencies.

### SUMMARY

In one aspect of the present application, a three-dimensional (3-D) antenna assembly arranged from a two-dimensional (2-D) antenna assembly, the 3-D antenna assembly comprises a plurality of 2-D antenna elements joined at a plurality of antenna element junctions, the joined plurality of 2-D antenna elements forming the 2-D antenna assembly, and a plurality of antenna patterns fashioned on at least one of the plurality of 2-D antenna elements, wherein the 2-D antenna assembly is arranged into the 3-D antenna assembly by creating an angle between adjoining 2-D antenna elements at each of the plurality of antenna element junctions and joining the plurality of 2-D antenna elements at a plurality of junction points.

In another aspect of the present application, a three-dimensional (3-D) antenna assembly, the 3-D antenna assembly comprises a plurality of 2-D antenna elements, and a plurality of antenna patterns fashioned on at least one of the plurality of 2-D antenna elements, wherein the 3-D antenna assembly is arranged by joining the plurality of 2-D antenna elements at a plurality of junction points.

In another aspect of the present application, method of producing a 3-D antenna assembly, comprises selecting a 2-D antenna element geometry, producing a 2-D antenna assembly including a plurality of 2-D antenna elements, wherein the 2-D antenna elements are commonly fashioned in the selected geometry, arranging an antenna pattern on at least one of the 2-D antenna elements, and forming the 3-D antenna assembly from the 2-D antenna assembly.

### BRIEF DESCRIPTION OF THE FIGURES

FIG. 1 is a graphical representation illustrating an embodiment of a 2D antenna assembly of the present application.

FIG. 2 is a graphical representation illustrating an embodiment of a 2D antenna assembly of the present application.

FIG. 3 is a graphical representation illustrating an embodiment of a 2D antenna assembly of the present application.

FIG. 4 is a graphical representation illustrating an embodiment of a 2D antenna assembly of the present application.

FIG. 5 is a graphical embodiment of a 2D antenna assembly of the present application.

FIG. 6 is a graphical representation illustrating an embodiment of a 3D antenna assembly of the present application.

FIG. 7 is a graphical representation illustrating an embodiment of a 3D antenna assembly of the present application.

FIG. 8 is a graphical embodiment of a 2D antenna assembly of the present application.

FIG. 9 is a flow chart illustrating an embodiment of a method of the present application.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. §112, sixth paragraph, only if the terms “means for” or “step for” are explicitly recited in the respective limitation.

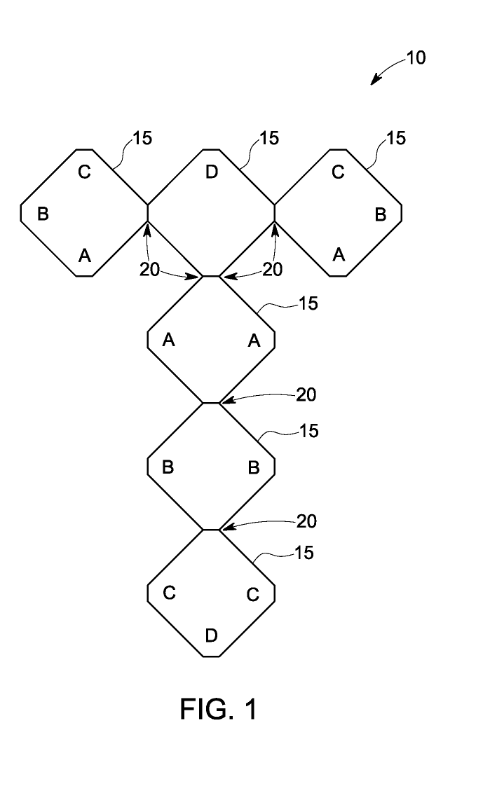

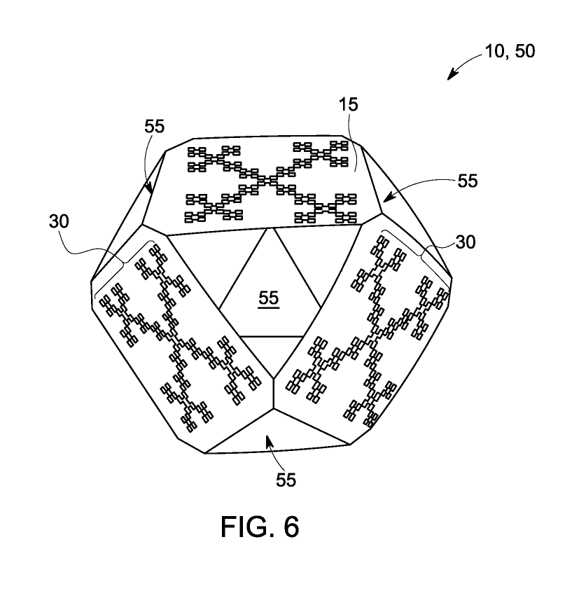

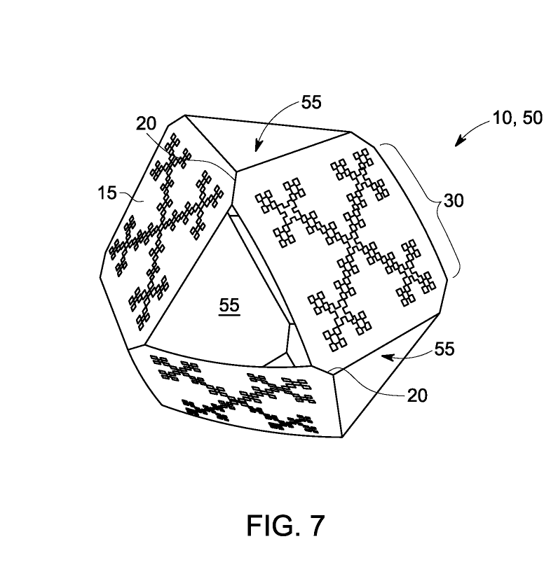

FIGS. 1-5 and 8 illustrate exemplary embodiments of 2-D antenna assemblies 10, 10′, 10″ for capturing Electromagnetic Energy. In general terms, the assemblies may also be effective at transmitting as well. These embodiments are based on six 2D-antenna elements 15, 15′, 15″ using various geometries, where the antenna elements 15, 15′, 15″ are then folded to create a 3-dimensional (3-D) assembly 50 (see FIGS. 6 and 7). These antenna elements 15, 15′, 15″ may be manufactured using standard printed circuit board processes, or printing with conductive inks for low power applications. Other processes known in the art to print or fabricate an antenna pattern or an antenna element may be utilized, and further any material for the element that may be fashioned into a 3-D antenna assembly 50 may be used. It is also contemplated that further embodiments are based in 2D-antenna assemblies 10, 10′, 10″ have more or less than six 2-D antenna elements 15, 15′, 15″.

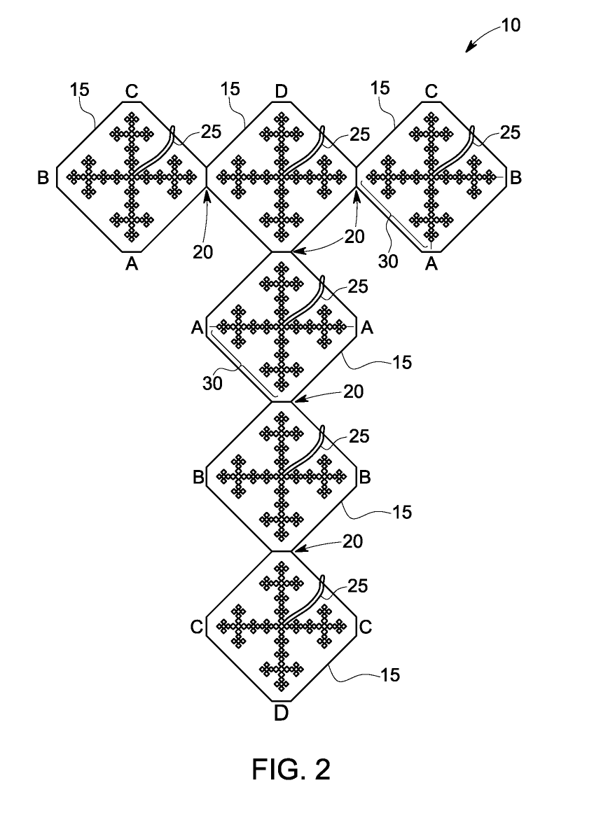

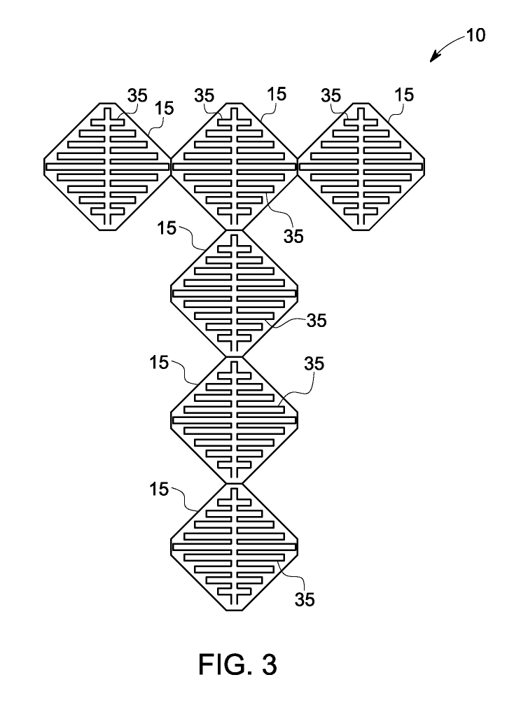

For wide-band energy, the embodiment of FIGS. 1-3 and 8 include a diamond, six-element 15 2-D assembly 10 with an antenna 30 printed in each element 15. Note that the particular fractal antenna 30 shape shown in FIG. 2 is exemplary only, and that the element 15 can include any fractal or non-fractal antenna pattern known in the art or derived specifically for the element 15. In fact, FIG. 3 illustrates a non-fractal antenna 35, which may also be considered a 1st-order fractal antenna.

For energy at a known frequency band, for example IEEE 802.11 Wi-Fi at 2.5 GHz, the diamond, six-element 15 coupled with an antenna design that is tuned specifically to 2.5 GHz may be preferred. FIG. 1 illustrates an exemplary 2-D antenna assembly 10 having six diamond 2-D antenna elements 15 coupled together in a pattern, each element 15 being coupled to the next at an antenna element junction 20. The 2-D antenna assembly 10 of FIG. 1 is exemplary in that numerous different geometries of the 2-D antenna elements 15 may be utilized. Furthermore, it should be noted that FIG. 1 is an exemplary illustration of a 2-D antenna assembly 10 in that there are no antenna patterns illustrated on each element 15. However, it should be understood that each element, or any number of the elements will have an antenna pattern and/or shape fashioned on the element 15.

Still referring to FIG. 1, the antenna element junctions 20 are fashioned such that each element 15 may be made to create an angle with its adjacent element 15. In other words, the junction 20 must be made to be flexible or hinged or may even be detachable such that the elements 15 may be moved to a preferred angle with respect to an adjoining element 15 and then reattached. In one embodiment, the 2-D antenna assembly 10 would be fashioned from a flexible material that would be able to accept a printed antenna on each element, and that would allow bending of the antenna element junctions 20 such that the 2-D antenna assembly 10 may be fashioned into a 3-D antenna assembly 50 as depicted in FIGS. 6 and 7. The 3-D antenna assembly 50 of FIGS. 6 and 7 would be fashioned by folding the 2-D antenna assembly 10 of FIG. 2 at the antenna element junctions 20 and joining the labeled junction points A, B, C, D. The commonly labeled junction points A, B, C, D are engaged and joined together, such that the elements 15 are joined by points A-A, B-B, C-C and D-D.

Referring now to FIG. 2, the 2-D antenna assembly 10 of FIG. 1 is further depicted in accordance with an embodiment with each of the 2-D antenna elements 15 including a fractal antenna 30. Once again, it should be understood that the fractal antenna 30, illustrated on each of the 2-D antenna elements 15 may be printed onto the elements 15, or may be fashioned onto the elements 15 using any known elements in the art of fashioning antenna elements of a material. It should be further noted that the system of the present application is not confined to including fractal antennas 30, but may also include non-fractal antennas according to the needs of the system. Of course, this is then also true for the 3-D antenna assembly 50 illustrated in FIGS. 6 and 7. In other words, the design is not limited to the fractal antennas 30 illustrated in FIG. 2, but may include any fractal antenna 30 known in the art or specifically designed for a particular system, or any non-fractal antenna known in the art or specifically designed for a particular system.

If required by the antenna being utilized on the element 15, an antenna cable 25 configured to relay the collected signal and/or energy from the antenna to a receiver in the system (not shown). Each of the antenna cables 25 will be consolidated in a single cable (not shown) when the 2-D antenna assembly 10 is configured into the 3-D antenna assembly 50. This consolidated cable may be configured to join each of the antenna cables 25 in the center of the 3-D antenna assembly 50, or be effectuated by routing each antenna cable 25 along the edges of the 2-D antenna elements 15 to a single point on the inside or outside surface of the 3-D antenna assembly 50. When each antenna cable 25 for each antenna element 15 is consolidated into a single cable, the overall received power is equal to the sum of each individual antenna element 15. Formula 1 below illustrates this concept where P is the overall received power and P₁-P₆ represents received power for each of the six antenna elements. This power formula (1) is true for the case of power harvesting and scavenging with the 3D antenna assembly 50 of the present application.

P=P₁+P₂+P₃+P₄+P₅+P₆ (1)

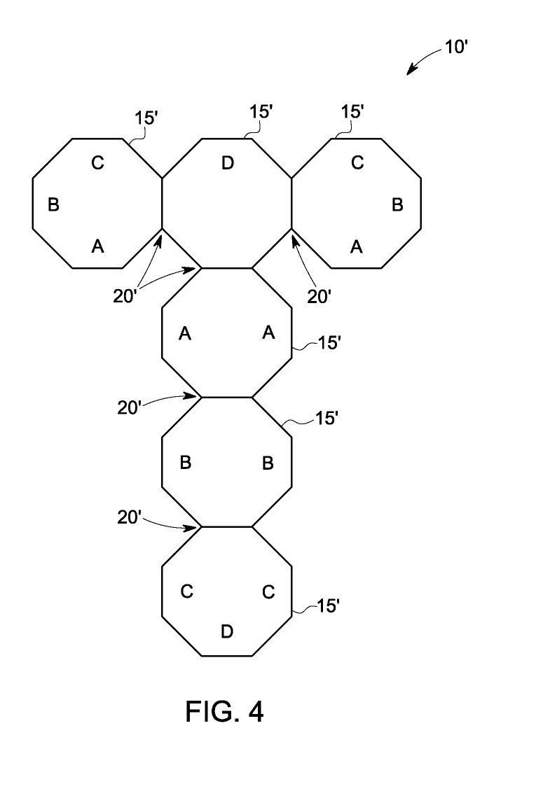

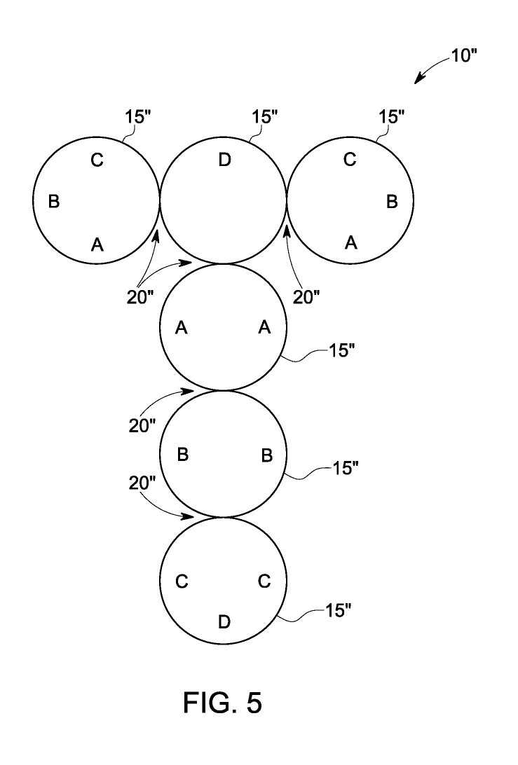

Referring now to FIGS. 4 and 5, a 2-D antenna assembly 10′, 10″ are shown in accordance with an embodiment with varying geometries for the 2-D antenna elements 15′, 15″. As in the same manner described above with respect to FIGS. 1-3, the 2-D antenna assemblies 10′, 10″ of FIGS. 4 and 5 may be folded along the antenna element junctions 20′, 20″ and joined at the junction points A, B, C, D, in order to arrive at a 3-D antenna assembly 50. Of course, the varying geometries of the antenna elements 15′, 15″ of FIGS. 4 and 5 will result in a 3-D antenna assembly 50 that does not exactly resemble the 3-D antenna assembly 50 of FIGS. 6 and 7, but will take on a slightly different 3-dimensional shape and also include varying 3-D antenna openings 55.

Now referring to FIG. 6, a 3-D antenna assembly 50 is depicted in accordance with an embodiment, this 3-D antenna assembly 50 being constructed from the 2-D antenna assembly 10 in FIG. 2. Again, the 2-D antenna elements 15 are folded or hinged at the antenna element junctions 20 in such a way to create a 3-D spherical shape and joined at each junction point A, B, C, D. As discussed previously, the junction points A, B, C, D are joined to one another in a secure fashion. Depending upon the material used for the 2-D antenna elements 15, the junction points A, B, C, D may be joined using an adhesive, by soldering, fusing, bolting, riveting, fastening, screwing, taping or any other method known in the art. Once the 3-D antenna assembly 50 is formed, it will be apparent that a number of 3-D antenna openings 55 are also formed, and take on a shape that is determined by the shape of the 2-D antenna elements 15. These openings 55 allow signals to pass through the 3-D antenna assembly 50 and to be collected by any of the other antennas present on any of the 2-D antenna elements 15. Once again, it should be noted that in this particular illustration, a fractal antenna 30 is shown on each of the 2-D antenna elements 15, but that any fractal or non-fractal antenna may be utilized according to the requirements of the system.

It should further be noted that the pattern created by the 2-D antenna elements 15 in FIG. 2 are only one way that the 2-D antenna assembly 10 may be fashioned. In other words, the left and right 2-D antenna elements in the top row of the 2-D antenna assembly 10 may be moved and positioned on any of the 2-D antenna elements 15 in the column of four elements. The only requirement being that the 2-D antenna assembly 10 is able to be fashioned into the 3-D antenna assembly 50. Also referring to FIGS. 6 and 7, it should be clear that the 3-D antenna assembly 50 of the present application may also be constructed by joining six individual 2-D antenna elements 15 together at what would be antenna element junctions 20 and the junction points A, B, C, D. In other words, the six-element 2-D antenna assemblies 10, 10′, 10″ of FIGS. 1-5 may instead be replaced by using six individual 2-D antenna elements 15, 15′, 15″, and individually joined together to create the 3-D antenna assembly 50 of FIGS. 6 and 7.

Still referring to FIGS. 6 and 7, a plurality of 3-D antenna openings 55 are naturally formed when the 2-D antenna assembly 10 is formed into the 3-D antenna assembly 50. The shape of the 3-D antenna openings 55 will be consistent, and dependent upon the geometry of the 2-D antenna element 15. As discussed previously, the 3-D antenna openings 55 may be left open such that signals pass through the openings 55 and are received by one of the 2-D antenna elements 15 opposite of that opening 55. In another embodiment, the openings 55 may be covered by a secondary antenna element (not shown) fashioned out of similar material used to the fashion the 2-D antenna element 15, and further including an antenna (either fractal or non-fractal) such that the entire 3-D antenna assembly 50 is fashioned from a material capable of receiving an antenna, and enclosed in a generally spherically shaped 3-D antenna assembly 50. Of course, particular embodiments may include the 3-D antenna assembly 50 that has some of the 3-D antenna openings 55 covered by a secondary antenna element, while others being left as openings 55. It should be further noted that the secondary antenna elements (not shown) would be joined with the 2-D antenna elements 15 by similar methods as discussed previously in the discussion of joining the 2-D antenna elements to one another at the junction points A, B, C, D.

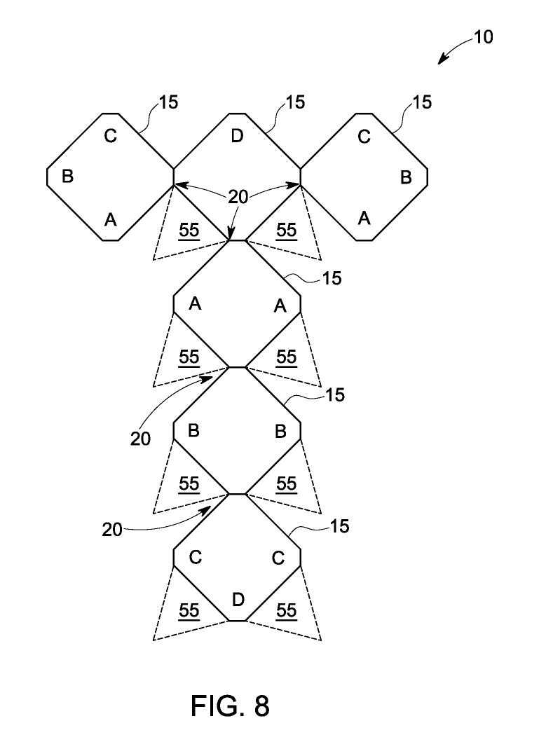

Referring now to FIG. 8, the 2D antenna assembly 10 of FIGS. 1-3 is once again utilized to illustrate the 3D antenna openings 55 as discussed previously in FIGS. 6 and 7. Here, a dashed line is used to show the shape of the openings 55 if the 2D antenna assembly 10 were folded into the 3D antenna assembly 50 of FIGS. 6 and 7. As further discussed above, the dotted lines may illustrate the boundaries of a secondary antenna element that may be utilized instead of an opening 55, that may further have some sort of antenna printed on it according to the previous specification. As further discussed above, the shape of the 3D antenna opening 55 is dependent upon the geometry of the antenna elements 15, and in this case, takes on a triangle shape.

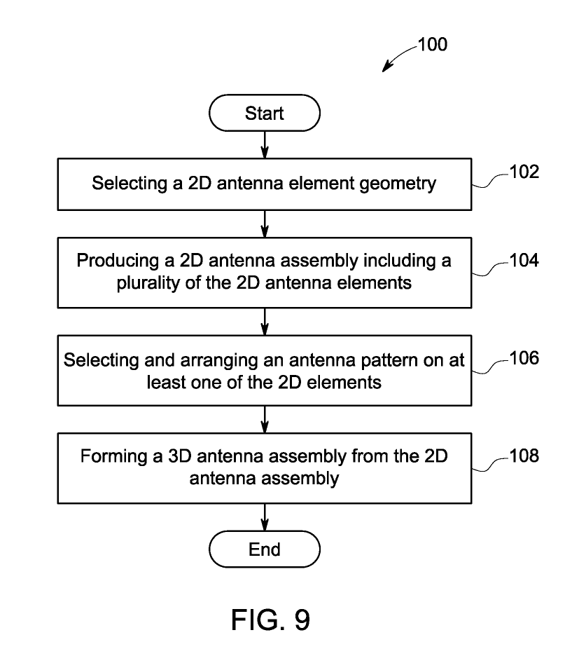

Referring now to FIG. 9, a method 100 of the present application is illustrated in accordance with an embodiment. In step 102, a 2-D antenna element shape is selected. As discussed above, a number of geometries may be utilized, including but not limited to a diamond shape of FIG. 3, a hexagon shape, an octagon shape, or even a circular shape as shown in FIG. 5. The 2-D antenna element shape may also include a square-shaped antenna element. However, such an element selection would create a 3-D antenna element in the shape of a cube. Such an antenna would be more useful than a 2-D antenna element on its own, but would only include three planes for capturing signals, in contrast to the multiple planes produced by the 3-D antenna assembly of FIGS. 6 and 7. This cubic 3-D antenna assembly would be viable and quite useful, as an alternative embodiment. In step 104, a 2-D antenna assembly is produced including a plurality of 2-D antennas. As discussed in the previous paragraph, the shape shown in FIGS. 1-5 may be utilized, or another shape that includes moving the left and right elements to any of the other elements in the four element column may be utilized, so long as the 2-D antenna element may be fashioned into a 3-D element. As discussed above, the material of the 2-D antenna element may be fashioned from standard printed circuit board material or flexible material used to receive printed conducted inks, or any other material known in the art utilized to receive a conductive circuit and further configured to be fashioned into the 3-D antenna assembly. As also discussed previously, the antenna elements may also be fashioned separately and not in the 2-D antenna assembly, and assembled into the 3-D antenna assembly 50 illustrated in FIGS. 6 and 7. In step 106, an antenna pattern is arranged on each of the 2-D elements. Again, as discussed above, the antenna pattern may be any fractal or non-fractal antenna as required, and may be arranged on the 2-D element by any means known in the art, including but not limited to printing or etching. In Step 108, a 3-D antenna assembly is formed from the 2-D antenna assembly by folding or bending or hinging the 2-D antenna assembly and joining the junction points appropriately as discussed above. As further discussed previously, using individual 2-D antenna elements would remove the need to fold, bend or hinge the 2-D antenna assembly, and would require that the 2-D antenna elements be joined together at the junction points in order to arrive at the 3-D antenna assembly of FIGS. 5 and 6.

An antenna that has a geometry that is 3-Dimensional and spherically-shaped has the capability of receiving more energy than a 2-Dimensional antenna while also minimizing or eliminating the need to rotate the antenna. An antenna assembly 50 that has multiple elements 15 that are based on self-similarity of repeated patterns of increasing size results in an antenna that has long length relative to its size and is capable of receiving signals that are not specific to any particular frequency or frequency range, but instead is a wide-band antenna that is capable of receiving signals over a significantly large dynamic range of frequencies, which makes it attractive in energy scavenging applications and potentially enables higher power type applications that were previously thought of as not possible. Applications today that use non-rechargeable batteries to power the system could potentially be replaced with supercapacitors that store energy that was captured from such an antenna and would eliminate the need to replace batteries. Alternatively, the stored energy could be used to charge secondary (rechargeable) batteries.

The technical advantages of this 3-Dimensional spherically-shaped antenna are 1) it has the capability to receive significantly more electromagnetic energy, 2) it is non-directional and therefore minimizes or eliminates the need to rotate. The primary commercial advantages is that this antenna has the capability to make various applications practical that were previously thought of as not possible.

Energy scavenging is a relatively new field that is primarily targeted at low-power remote-sensing applications that consume 1 mW or less. This type of antenna may have the capability of improving this by orders of magnitude.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A three-dimensional (3-D) antenna assembly comprising:
a plurality of 2-D antenna elements joined at a plurality of antenna element junctions, the joined plurality of 2-D antenna elements forming a 2-D antenna assembly; and
a plurality of antenna patterns fashioned on at least one of the plurality of 2-D antenna elements,
wherein the 2-D antenna assembly is arranged into the 3-D antenna assembly by creating an angle between adjoining 2-D antenna elements at each of the plurality of antenna element junctions and joining the plurality of 2-D antenna elements at a plurality of junction points.

2. The 3-D antenna assembly of claim 1, wherein the plurality of 2-D antenna elements are fashioned in a common geometry.

3. The 3-D antenna assembly of claim 2, wherein the common geometry includes any one of a diamond geometry, a circle geometry, an octagon geometry, a hexagon geometry and a square geometry.

4. The 3-D antenna assembly of claim 1, wherein the plurality of antenna patterns are fractal antenna patterns.

5. The 3-D antenna assembly of claim 1, wherein the plurality of antenna patterns are non-fractal antenna patterns.

6. The 3-D antenna assembly of claim 1, wherein the plurality of junction points are joined by any of fusing, soldering, gluing, fastening, bolting, screwing, riveting and taping.

7. The 3-D antenna assembly of claim 1, wherein the 2-D antenna assembly is fashioned from a flexible material such that the angle between adjoining 2-D antenna elements is creating by bending or folding the 2-D antenna element.

8. The 3-D antenna assembly of claim 1, further including an antenna cable for each of the plurality of antennas, wherein the antenna cables are coupled together and provided to a receiver, and wherein a power input to the receiver is equal to the sum of a power collected by each of the plurality of antennas.

9. The 3-D antenna assembly of claim 1, wherein the 3-D antenna assembly includes a plurality of secondary antenna elements configured to cover a plurality of openings in the 3-D antenna assembly.

10. The 3-D antenna assembly of claim 1, wherein the antenna pattern is etched on the 2-D antenna elements.

11. The 3-D antenna assembly of claim 1, wherein the antenna pattern is printed on the 2-D antenna elements.

12. The 3-D antenna assembly of claim 1, wherein the antenna pattern is cut from a conductive material and affixed to the 2-D antenna elements.

13. A three-dimensional (3-D) antenna assembly comprising:
a plurality of 2-D antenna elements; and
a plurality of antenna patterns fashioned on at least one of the plurality of 2-D antenna elements,
wherein the 3-D antenna assembly is arranged by joining the plurality of 2-D antenna elements at a plurality of junction points.

14. The 3-D antenna assembly of claim 13, wherein the plurality of 2-D antenna elements are fashioned in a common geometry.

15. The 3-D antenna assembly of claim 14, wherein the common geometry includes any one of a diamond geometry, a circle geometry, an octagon geometry, a hexagon geometry and a square geometry.

16. The 3-D antenna assembly of claim 13, wherein the plurality of antenna patterns are fractal antenna patterns.

17. The 3-D antenna assembly of claim 13, wherein the plurality of antenna patterns are non-fractal antenna patterns.

18. The 3-D antenna assembly of claim 13, further including an antenna cable for each of the plurality of antennas, wherein the antenna cables are coupled together and provided to a receiver, and wherein a power input to the receiver is equal to the sum of a power collected by each of the plurality of antennas.

19. The 3-D antenna assembly of claim 13, wherein the 3-D antenna assembly includes a plurality of secondary antenna elements configured to cover a plurality of openings in the 3-D antenna assembly.

20. The 3-D antenna assembly of claim 13, wherein the antenna pattern is etched on the 2-D antenna elements.

21. The 3-D antenna assembly of claim 13, wherein the antenna pattern is printed on the 2-D antenna elements.

22. The 3-D antenna assembly of claim 13, wherein the antenna pattern is cut from a conductive material and affixed to the 2-D antenna elements.

23. A method of producing a 3-D antenna assembly, comprising:
selecting a 2-D antenna element geometry;
producing a 2-D antenna assembly including a plurality of 2-D antenna elements, wherein the 2-D antenna elements are commonly fashioned in the selected geometry;
selecting and arranging an antenna pattern on at least one of the 2-D antenna elements; and
forming the 3-D antenna assembly from the 2-D antenna assembly.
